(19) United States
(12) Patent Application Publication
(10) Pub. No.: US 2017/0176696 A1
(43) Pub. Date: Jun. 22, 2017

(54) WIRELESS NON-INTRUSIVE REMOTE MONITORING OPTICAL CONNECTION APPARATUS UTILIZING RFT PHOTO-DETECTOR

(71) Applicant: RAX CONNECT LTD., Haifa (IL)

(72) Inventor: Benny Gaber, Haifa (IL)

(73) Assignee: RAX CONNECT LTD., Haifa (IL)

(21) Appl. No.: 15/118,176

(22) PCT Filed: Feb. 11, 2015
(86) PCT No.: PCT/IB2015/051021

§ 371 Date: Aug. 11, 2016

Related U.S. Application Data
(60) Provisional application No. 61/938,301, filed on Feb. 11, 2014.

(51) Int. Cl. G02B 6/38; G02B 6/42

(52) U.S. Cl. CPC G02B 6/3895; G02B 6/4286; G02B 6/4287

(57) ABSTRACT

A non-intrusive remote wireless monitoring system is described for light signals between two fiber-optic communication lines. Most of the light from a transmitting fiber (6) goes to a receiving fiber (6′) whereas part of the light is harvested from an opening in the cladding (11) of the fiber by a photo-detector (9) connected to a passive ASIC (16) and a transmitting antenna (10). The ASIC has a unique ID for efficient monitoring of the communication lines.

### FIELD OF THE INVENTION

The present invention generally relates to wireless non-intrusive monitoring of light signals between two fiber optic communication lines.

### BACKGROUND OF THE INVENTION

Non-intrusive monitoring of light signals between two fiber optic communication lines is required in many applications, such as distribution frames, patch panels, fiber optic adapters and termination devices. Monitoring is required in both transmission and reception. One example of wireless remote monitoring of active optical lines is described in PCT Patent Application PCT/US2013/073987, entitled “Non-Intrusive Monitoring Optical Connection Apparatus” to Benny Gaber, Israel.

### SUMMARY

The present invention seeks to provide methods and apparatus for non-intrusive wireless remote monitoring of light signals between two fiber-optic communication lines, such as distribution frames, patch panels, fiber optic adapters and termination devices. Most of the light from the transmitting fiber goes to the receiving fiber in the fibers core, in both directions, whereas a small part of the light exits from an opening in the cladding onto a photo-detector.

In one embodiment, a short ferrule is disposed between two fiber optic communication line connectors or the ferrule end of a fiber-optic line having an opening in its cladding. Most of the light from the transmitting fiber goes to the receiving fiber through the fibers core and part of the light travelling in the cladding is harvested from the opening in the cladding by a photo-detector near or attached to the opening and connected to an ASIC (Application-Specific Integrated Circuit) and RFT (Radio Frequency Transponder) antenna. A monitoring antenna activates the RFT and reads the photo-detector data.

The optical element harvests only a very small part of the light signals, thus achieving efficient non-intrusive monitoring without interrupting the ongoing transmission of optical information data in both directions between the two fiber optic communication lines.

The ASIC has a unique ID that differentiates between individual connections. The unique ASIC ID allows for an automated cable connectivity management system of the physical layer.

### BRIEF DESCRIPTION OF THE DRAWINGS

The disclosure will be understood and appreciated more fully from the following detailed description taken in conjunction with the drawings in which:

FIG. 1A is a schematic general view illustration of a communication patch panel cabinet with antenna for activating and reading the RFT (radio frequency ID) non-intrusive monitoring, in accordance with an embodiment of the present invention;

FIG. 1B is a partial view of FIG. 1A;

FIG. 2A is a general view of fiber optic connector with RFT on ferrule, in accordance with an embodiment of the present invention;

FIG. 2B is a schematic illustration of a fiber optic end connector with photo-detector attached to RFT, in accordance with an embodiment of the present invention;

FIG. 2C is a schematic sectional view of FIG. 2A;

FIG. 3 is a schematic illustration of a ferrule with a cut in its cladding with ASIC and photo-detector attached to RFT antenna on photo-detector holder, in accordance with an embodiment of the present invention;

FIG. 4 is a schematic illustration of the RFT antenna on the fiber optic connector, in accordance with an embodiment of the present invention;

FIG. 5 is a schematic illustration the RFT antenna on the fiber optic end line, in accordance with an embodiment of the present invention; and

FIG. 6 is a schematic illustration of a conducting coating on ferrule connecting photo-detector to RFT antenna, in accordance with an embodiment of the present invention.

### DETAILED DESCRIPTION OF EMBODIMENTS

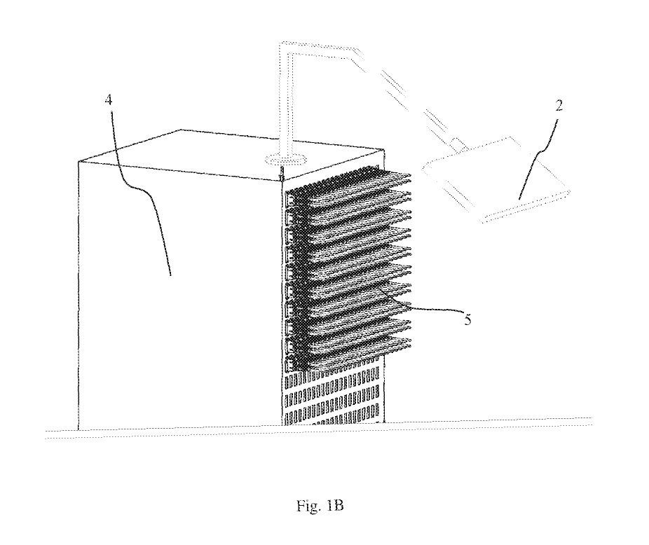

Reference is now made to FIG. 2A, which illustrates a monitoring system (apparatus) 13 in accordance with an embodiment of the invention. The system includes two fiber optic lines 6 and 6′, one of which is a transmitting fiber 6 and the other is a receiving fiber 6′. Each line ends in an optical connector 5. The connectors 5 may be connected via a ferrule 7.

FIG. 2B illustrates a fiber optic end connector 5 with a ferrule connection 7′ at the end face of the connector.

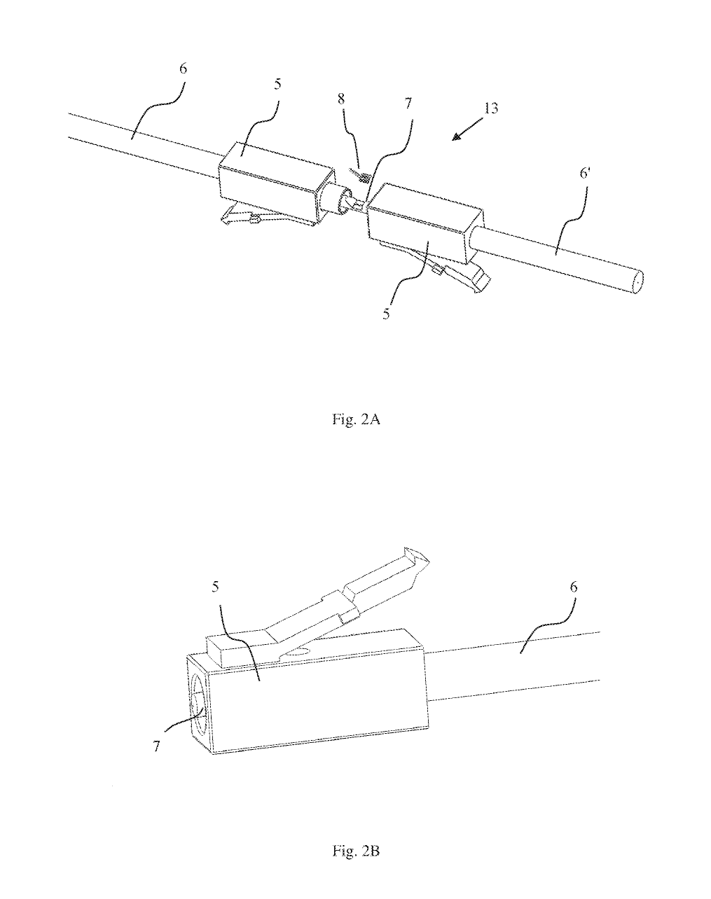

As seen in FIG. 2C and more in detail in FIG. 3, the optic line 6 has a cutout or opening in its cladding. A photo-detector 9 is mounted on a photo-detector holder 8, which is assembled or attached on the cutout (holder 8 is also shown separately in FIG. 2A). The exposed cladding 11 is clearly seen in FIG. 3. The photo-detector 9 is arranged to detect light emitted (“harvested”) from the exposed cladding 11. An ASIC (Application-Specific Integrated Circuit) 16 is mounted on holder 8. ASIC 16 has an identifier (ID) unique for the photo-detector data detected by photo-detector 9.

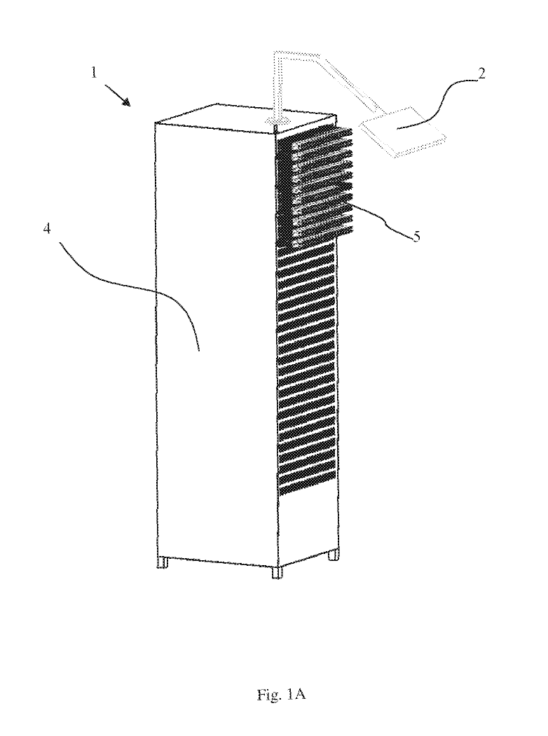

A transmitting antenna 10 is also located on holder 8 and is operative to transmit the photo-detector data and the ID to an external monitoring system 1 (FIG. 1A). For example, transmitting antenna 10 may be a RFT (Radio Frequency Transponder) antenna.

Reference is now made to FIGS. 1A and 1B, which illustrate an example of the non-intrusive monitoring system 1 implemented in a communication patch panel cabinet 4. The cabinet 4 includes a plurality of connectors 5. As described above, for each connector there is a transmitting antenna. A monitoring antenna 2 is mounted on or near cabinet 4 and is arranged to activate the RFT antenna (FIG. 2C), which when activated transmits the data and ID to monitoring antenna 2 for further processing.

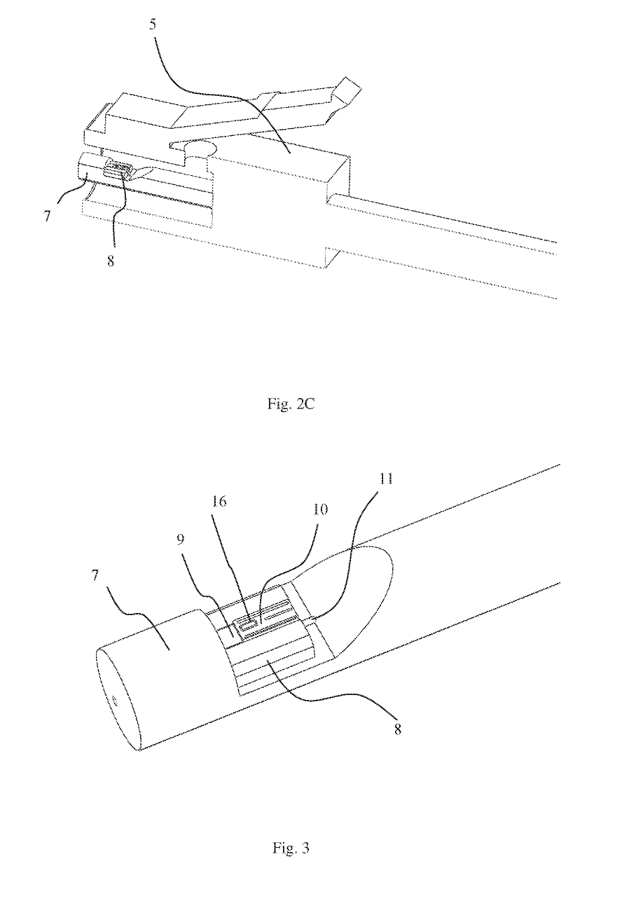

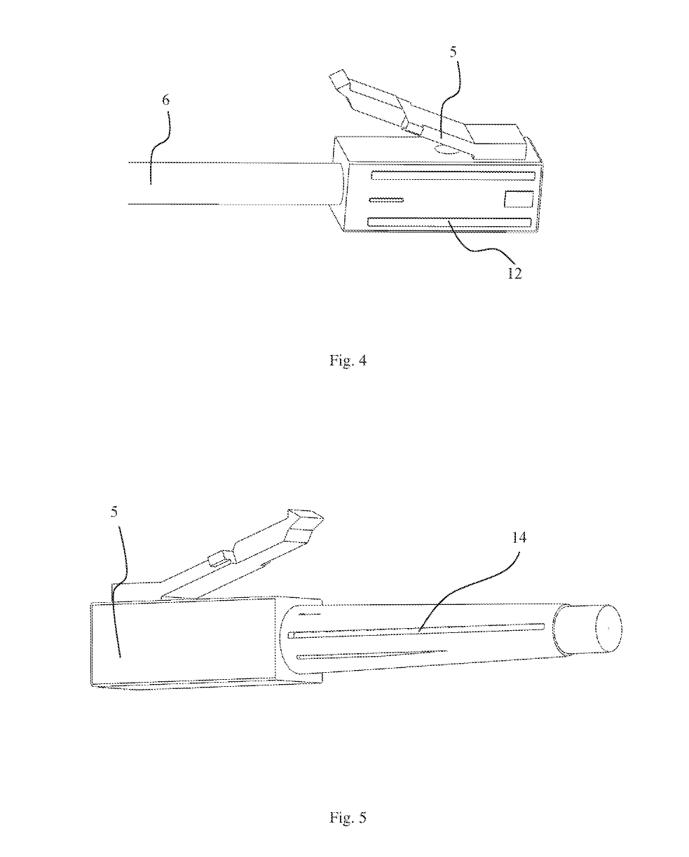

The transmitting antenna can be placed in various places. As seen in FIG. 4, an RFT antenna 12 is disposed on connector 5. As seen in FIG. 5, an RFT antenna 14 is disposed on a fiber optic end line.

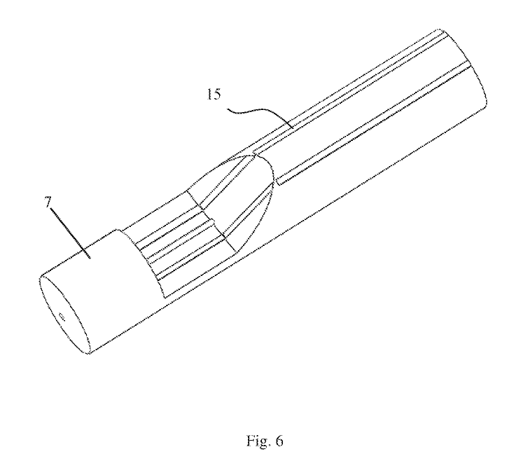

Reference is now made to FIG. 6. In any of the above-described embodiments, a conductive coating 15 may be deposited or otherwise formed on ferrule 7 for electrically connecting the photo-detector and ASIC to the RFT antenna.

1. A non-intrusive wireless remote monitoring apparatus comprising:
a fiber optic communication line comprising a transmitting fiber having a core and a cladding with an opening formed in the cladding, said transmitting fiber arranged to transmit light to a receiving fiber,
a photo-detector arranged to detect light in said opening, wherein most of the light from the transmitting fiber goes to the receiving fiber (6′) through the core and part of the light travelling in the cladding is harvested from the opening in the cladding by said photo-detector;
an ASIC (Application-Specific Integrated Circuit) comprising an identifier (ID) unique for photo-detector data detected by said photo-detector; and
a transmitting antenna operative to transmit said photo-detector data and said ID.

2. The apparatus according to claim 1, wherein said transmitting antenna comprises a RFT (Radio Frequency Transponder) antenna, and the apparatus further comprises a monitoring antenna operative to activate said transmitting antenna to receive said data and said ID from said transmitting antenna.

3. The apparatus according to claim 1, wherein said transmitting fiber and said receiving fiber are connected by optical connectors.

4. The apparatus according to claim 1, wherein said transmitting fiber and said receiving fiber (6′) are connected by optical connectors and at least one ferrule.

5. The apparatus according to claim 4, wherein said transmitting antenna is mounted in a portion of one of said optical connectors.

6. The apparatus according to claim 4, wherein said ASIC and said transmitting antenna are mounted in a portion of said ferrule.

7. The apparatus according to claim 4, wherein said transmitting antenna is mounted in a portion of said transmitting fiber.
